(19) United States
(12) Patent Application Publication
(10) Pub. No.: US 2012/0111603 A1
(43) Pub. Date: May 10, 2012

(54) POWER AND/OR TELECOMMUNICATION CABLE COMPRISING A REINFORCED GROUND-CHECK CONDUCTOR

(76) Inventors: Jorge Cofre, (US); Thierry Seux, Sablons (FR)

(21) Appl. No.: 12/943,111

(22) Filed: Nov. 10, 2010

(51) Int. Cl. H01B 7/17

(52) U.S. Cl. 174/115; 174/110 R

(57) ABSTRACT

A ground-check conductor (20) includes an electrical conductor (22) surrounded by an electrically insulated layer (23), where the ground-check conductor further includes an elongated central core (21) surrounded by said electrical conductor (22), the elongated central core being directly in physical contact with said electrical conductor, and having a breaking strength of at least 3500 N.

### BACKGROUND

1. Field of the Invention

The present invention relates to a reinforced ground-check conductor used in a power and/or telecommunication cable.

More particularly, the power and/or telecommunication cable is used in mines and similar applications such as severe abrasion and dark environment.

2. Description of Related Art

A conventional power or telecommunication cable includes one or more conductor elements, especially insulated conductor elements, with a protective outer sheath. An electrical power cable is typically constructed with conductor elements formed of copper wire for efficiently conducting electrical power on whatever scale is desired. A telecommunication cable is typically constructed of relatively small wire conductor elements for conducting electrical signals and/or fiber-optic strands for conducting optical signals.

Power and/or telecommunication cables are used in many environments. One of the harshest environments for cables is mining operations in dark environment.

Mining cable classically comprises a plurality of conductor elements being surrounded by a protective outer sheath. The plurality of conductor elements comprises:

at least one power insulated conductor, and more preferably three power insulated conductors,

one ground-check conductor providing fail-safe ground monitoring for maximum safety, said ground-check conductor being only constituted from a elongated electrical conductor as central core, surrounded by an electrically insulated layer, and

at least one ground conductor that acts as security element in case of short circuit, said ground conductor being only constituted from an elongated electrical conductor without any electrically insulated layer surrounding said conductor. In some embodiments, said ground conductor can be surrounded by a non-electrically insulated layer such as a tape, in order to mainly facilitate its identification.

The cables used in mining operations tend to be subjected to severe abrasion due to equipment, traffic, and mining materials moving over or along the mining cable. In addition, the lack of cable visibility in said dark environment frequently produces cable crushing or abrasive wearing by the mining trucks and the shovel machines.

Hence, the first element to be mechanically damaged in said mining cable concerns the ground-check conductor. When mechanical damages occur on the mining cable, the electrical conductor of the ground-check conductor, which is the central core of the ground check conductor, is damaged, so that the cable loses its security check element that guarantees the continuity of the grounding system.

### OBJECTS AND SUMMARY

The present invention seeks to solve the above-mentioned problems of the prior art, and proposes a ground-check conductor with an improved breaking strength resistance, able to be used in a power and/or telecommunication cable, more particularly in a mining cable.

To this end, an object of the present invention is to provide a ground-check conductor comprising an electrical conductor surrounded by an electrically insulated layer, wherein the ground-check conductor further comprises an elongated central core surrounded by said electrical conductor, said elongated central core being directly in physical contact with said electrical conductor, and having a breaking strength of at least 3500 N.

Thanks to the association of the electrical conductor with the elongated central core used as strength member, the ground-check conductor is able to withstand to mechanical damages occurring on the cable wherein it belongs.

The method classically used to determine the breaking strength of the elongated central core is the one according to the standard ASTM B3 (2004).

In a particular embodiment, the electrical conductor and the electrically insulated layer are positioned concentrically around the elongated central core.

The elongated central core according to the invention may include a fibrous strength member, said fibrous strength member being more preferably twisted along its longitudinal axis.

Said fibrous strength member may be selected among aramid fibers, polyamide fibers, and polyester fibers, or mixtures thereof. The preferred type of aramid fibers are aramid yarns.

In a particular embodiment, the grounded-check cable may comprise a separator surrounding the electrical conductor, and positioned between the electrical conductor and the electrically insulated layer. Said separator can avoid excessive penetration of the material constituting the electrically insulated layer, especially during the extrusion process of said material.

In a preferred embodiment, the ground-check conductor according to the invention only comprises the elongated central core, the electrical conductor, and the electrically insulated layer, and optionally a separator positioned between the electrical conductor and the electrically insulated layer.

The electrical conductor is classically made from one or several metallic elements such as copper, or tinned copper, so that it can contain only one or several metallic elements.

It may comprise an assembly of several electrical wires surrounding the elongated central core, or a layer of a metallic material surrounding the elongated central core.

The dimensional and voltage requirements of the ground-check conductor according to the invention preferably satisfies part 3.12.2 of the ICEA S-75-381-2008 standard, and may be as given in tables 3-12, 3-21 and 3-22 of said standard.

In a first embodiment according to this standard, the electrical conductor of the ground check conductor has a minimum of 49 strands of annealed coated or uncoated copper wire may be used. One understands by the expression “coated copper” copper which is a tinned copper. If a larger size ground-check conductor is utilized, the minimum number of wires may not be less than specified for a power conductor of the same size (see Table 3-25 of the ICEA S-75-381-2008 standard). Said ground check conductor may include a polyester tape used as separator, wrapped around the electrical conductor and disposed between the electrical conductor and the electrically insulated layer.

In a second embodiment according to this standard, the electrical conductor of the ground-check conductor may contain a minimum of 28 strands of annealed coated or uncoated copper laid around a core of non-metallic material, the cross-sectional area of the conductor may not be less than 0.912 mm². Said ground-check conductor may include as well a polyester tape as separator wrapped around the electrical conductor and disposed between the electrical conductor and the electrically insulated layer. The ground-check conductor may typically be positioned in the center of the mining cable.

The electrically insulated layer material of the ground-check conductor is preferably an extrudable material, so that the ground-check conductor includes an extruded electrically insulated layer. Said electrically insulated layer material may be one of the types given in Table 3-2 of the standard ICEA S-75-381-2008 (e.g. ethylene propylene rubber (EPR), crosslinking polyethylene (XLPE), chlorinated polyethylene, polypropylene, thermoplastic elastomer, or chlorosulfonated polyethylene) and shall meet the requirements specified in Table 3-2 of the standard ICEA S-75-381-2008.

Another object according to the invention relates to a power and/or telecommunication cable including several conductor elements surrounded by a protective outer sheath, wherein one of the conductor elements is a ground-check conductor according to the present invention.

In a particular embodiment, the several conductor elements further comprise at least one power insulated conductor, and more preferably three power insulated conductors, and at least one ground conductor, so as to form a mining cable.

The preferred cable type according to the invention is a SHD-GC round three-conductor cables including three power insulated conductors, two ground conductors, and one ground-check conductor such as defined in the present invention, according to the ICEA 5-75-381-2008 standard, and more particularly according to part 3.10.3.3. of the ICEA S-75-381-2008 standard (cf. 5001 to 25000 Volts).

Other types of cable may be as well considered according to ICEA S 75-381-2008 standard, such as:
a G-GC cable including three power insulated conductors, three ground conductors, and one ground-check conductor according to the invention;
a G-CGC cable including three power insulated conductors, three ground conductors, and one ground-check conductor according to the invention, the ground-check conductor being in the center of the cable; or
a shielded SHD-CGC cable including three power insulated conductors, three ground conductors, and one ground-check conductor according to the invention, the ground-check conductor being in the center of the cable.

As mentioned before, one of the harshest environments for cables is mining operations in dark environment, so that the nature of the protective outer sheath may be critical. Technical solutions exist to visualize the cable so that the cable is less subjected to severe abrasion.

The first variant consists in using a protective outer sheath comprising a first layer able to emit light radiation, and a second layer made of a light transmitting thermoplastic polyurethane (TPU) material surrounding the first layer, so that the first layer is visible through the second layer.

The second variant consists in using a protective outer sheath such as an outer rubber sheath pigmented with a fluorescent pigment. However, said outer sheath presents low durability of the fluorescent pigments due to direct exposure to the ground, air, water and UV light.

The third variant is to use a reflective tape helically wrapped over the protective outer sheath of the cable. However, said additional reflective tape risks to be easily destructed due to severe use in mining conditions.

The fourth variant consists in using a protective outer sheath comprising a first layer as separator element, and a second layer made of an extrudable material such as mentioned in table 3-3 of ICEA S 57-381-2008. The separator element can typically be a tape containing nylon and/or polyester.

Among these four variants, the first variant is preferred since it proposes a cable showing both high abrasion resistance and a good visibility in dark environment, more particularly in outdoor dark environment.

### BRIEF DESCRIPTION OF THE DRAWINGS:

The present invention will become more fully understood from the detailed description given herein below and from the accompanying drawings which are given by way of illustration only, and thus, which are not limits of the present invention, and wherein:

FIG. 1 represents a schematic cross-sectional view of a ground-check conductor according to the invention.

FIG. 2 represents a schematic cross-sectional view of a cable including the ground-check conductor according to FIG. 1.

For reasons of clarity, the same elements are designed by identical references. Similarly, only those elements that are essential for understanding the invention are shown in diagrammatic manner, and scale is not complied with.

### DETAILED DESCRIPTION:

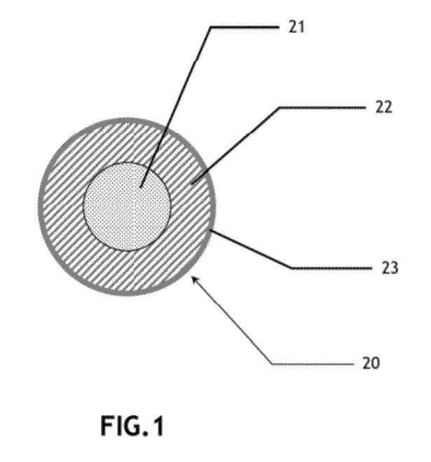

Referring to FIG. 1, the ground-check conductor is constituted by an elongated central core 21 as twisted aramid yarns, directly surrounded by an electrical conductor of copper strands 22 along said core 21. Said strands 22 are surrounded by an electrically insulated polymeric layer 23 along said strands 22.

The electrical conductor 22 as well as the electrically insulated layer 23 are concentrically positioned around the elongated central core 21.

In the example illustrated in FIG. 1, the cross section of the elongated central core 21 is of specific diameter according to each design, and the twisted aramid yarns are commercialized by Teijin under the reference Twaron D2200 19320 dtex Z50. Said twisted aramid yarns have a breaking strength of 3900 N.

The electrical conductor 22 is a stranded conductor with dimensions according to part 3.12.2 of the ICEA S-75-381-2008 standard.

The electrically insulated polymeric layer 23 is made from an extruded polymeric material such as material based on EPDM resin, commercialized by ECC under the reference Superohm 240-R.

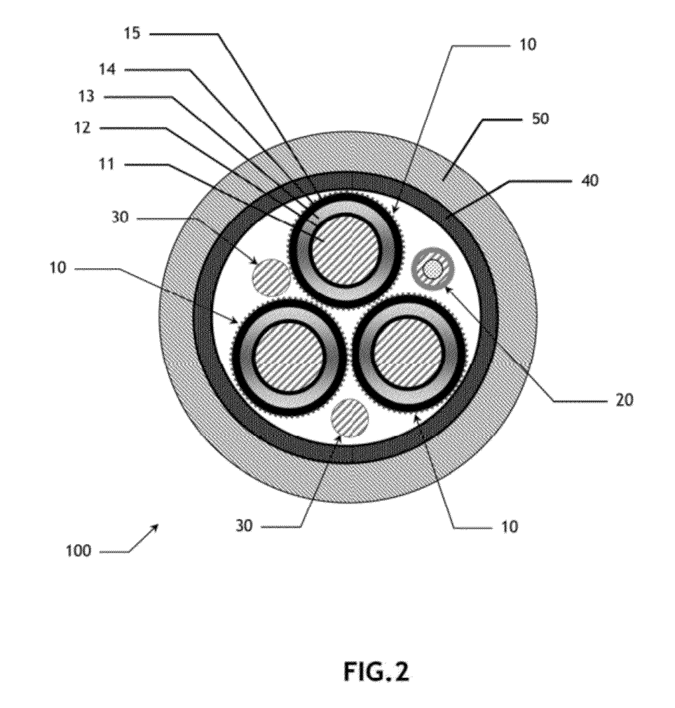

Referring to FIG. 2, the cable 100 includes a plurality of conductor elements 10,20,30, said plurality of elements being surrounded by a protective outer sheath 40a,50. Said cable schematically illustrates a SHD-GC cable (5001 to 25000 Volts) according to part 3.10.3.3 of the ICEA S-75-381-2008 standard.

The insulated conductor elements comprise three power insulated conductors 10, one ground-check conductor 20 according to the FIG. 1, and two ground conductors 30. A power insulated conductor 10 is for example composed of a plurality of stranded conductor wires 11 surrounded successively by a first semiconductor layer 12, a dielectric insulation 13, a second semiconductor layer 14, and a shield 15.

In FIG. 2, the protective outer sheath 40,50 can be a two-layer sheath comprising:

an inner layer 40 being a light emitting tape wrapped around the conductor elements 10,20,30, and

an extruded outer layer 50 of light transmitting thermoplastic polyurethane surrounding said inner layer 40.

The outer layer 50 is directly in physical contact with the inner layer 40 in order to see visually the inner layer through the outer layer, especially in a dark environment

In another example, the protective sheath can be a two layer sheath comprising:
a separator layer 40 such as a polyester tape, which is wrapped around the conductor element 10,20,30, and
an extruded outer layer 50 of a polymeric material such as indicated in Table 3-3 of ICEA S-75-381-2008 standard.

The ground-check conductor and the cable as respectively represented in FIG. 1 and in FIG. 2 have a circular cross section. However, the circular cross section is given by way of illustration, and thus other forms can be considered such as for example a flat cross section.

1. Ground-check conductor comprising:
an electrical conductor surrounded by an electrically insulated layer, wherein the ground-check conductor further includes an elongated central core surrounded by said electrical conductor, said elongated central core being directly in physical contact with said electrical conductor, and having a breaking strength of at least 3500 N.

2. Ground-check conductor according to claim 1, wherein the elongated central core includes a fibrous strength member.

3. Ground-check conductor according to claim 2, wherein the elongated central core is selected from the group consisting of aramid fibers, polyamide fibers, and polyester fibers, or mixtures thereof.

4. Ground-check conductor according to claim 3, wherein the aramid fibers are aramid yarns.

5. Ground-check conductor according to claim 1, wherein said conductor only has the elongated central core, the electrical conductor, and the electrically insulated layer, and optionally a separator surrounding the electrical conductor and positioned between the electrical conductor and the electrically insulated layer.

6. Power and/or telecommunication cable including several conductor elements surrounded by a protective outer sheath, wherein one of the conductor elements is a ground-check conductor according to claim 1.

7. Power and/or telecommunication cable according to claim 6, wherein the several conductor elements further comprise at least one power insulated conductor, and at least one ground conductor.

8. Power and/or telecommunication cable according to claim 6, wherein the protective outer sheath comprises:
a first layer able to emit light radiation; and
a second layer made of a light transmitting thermoplastic polyurethane (TPU) material surrounding the first layer, so that the first layer is visible through the second layer.

9. Power and/or telecommunication cable according to claim 6, wherein the protective outer sheath comprises:
a first layer as separator element; and
a second layer made from an extrudable material such as mentioned in table 3-3 of ICEA S 75-381-2008 standard.
